(19) United States
(12) Patent Application Publication
(10) Pub. No.: US 2024/0119414 A1
(43) Pub. Date: Apr. 11, 2024

(54) PART MANAGEMENT SYSTEM AND PART MANAGEMENT METHOD

(71) Applicant: TOYOTA JIDOSHA KABUSHIKI KAISHA, Toyota-shi (JP)

(72) Inventor: Nobuhiro YOSHIDA, Aichi-gun (JP)

(73) Assignee: TOYOTA JIDOSHA KABUSHIKI KAISHA, Toyota-shi (JP)

(21) Appl. No.: 18/461,100

(22) Filed: Sep. 5, 2023

(30) Foreign Application Priority Data
Oct. 6, 2022 (JP) 2022-161332

(51) Int. Cl. G06Q 10/0875

(52) U.S. Cl. CPC G06Q 10/0875

(57) ABSTRACT

To provide a part management system in which the number of processes that involve manual operation in managing materials is reduced. Provided is a part management system including: a part delivery track record information acquisition unit; a recording unit; an anomalous state detection unit; a part name determination information acquisition unit; a part number identifying unit; an approach calculation unit, and a display unit.

### CROSS REFERENCE TO RELATED APPLICATIONS

This application is based upon and claims the benefit of priority from Japanese patent application No. 2022-161332, filed on Oct. 6, 2022, the disclosure of which is incorporated herein in its entirety by reference.

### BACKGROUND

The present disclosure relates to a part management system and a part management method.

To date, methods for managing materials have been developed. Japanese Unexamined Patent Application Publication No. 2015-043138 describes how the acceptance inspection and temporary placement positions of materials arriving at a site can be tracked based on image information of the materials and the site. When work (i.e., operation) is performed regarding a package at a site, a first image information is acquired by capturing an image of the package using a portable terminal and at the same time, material information is acquired from an information medium. Here, in synchronization with the timing of the image-capturing by the portable terminal, a second image information is acquired by capturing an image of the package together with its surrounding area using a fixed camera installed at the site. Based on the second image information, the placement position of the package at the site is calculated, and the first image information, the material information, and the calculated placement position are stored as management data in a database of the server. The storage status of the package at the site is identified by searching the database.

### SUMMARY

In Japanese Unexamined Patent Application Publication No. 2015-043138, in order to acquire material information, it is necessary to capture an image of an information medium including material information for identifying packaged materials using a portable terminal. Therefore, in the method described in Japanese Unexamined Patent Application Publication No. 2015-043138, the operator's workload in managing materials may increase. In view of the above, an object of the present disclosure is to provide a part management system in which the number of processes that involve manual operation in managing materials is reduced.

According to an aspect of the present disclosure, a part management system includes:
a part delivery track record information acquisition unit configured to acquire part delivery track record information;
a simulation unit configured to execute a simulation of a part storage space based on the acquired part delivery track record information;
a recording unit configured to record stored-parts information of the part storage space based on the simulation;
an anomalous state detection unit configured to photograph the part storage space to detect parts that are in an anomalous state;
a part name determination information acquisition unit configured to acquire part name determination information of the parts that have been detected as being in the anomalous state;
a part number identifying unit configured to identify a part number of each of the respective parts that are in the anomalous state by comparing the acquired part name determination information with the acquired stored-parts information;
an approach calculation unit configured to acquire logistics operation information of the parts that have the respective part numbers identified by the part number identifying unit and have been detected as being in the anomalous state, and to calculate an approach to be taken for handling the parts that have been detected as being in the anomalous state; and
a display unit configured to display the calculated approach to be taken in handling the parts that have been detected as being in the anomalous state.

By the above configuration, it is possible to provide a part management system in which the number of processes that involve manual operation in managing materials is reduced.

The part management system according to the present disclosure is characterized in that the part name determination information includes at least one of information on a part storage space, the time of occurrence of the anomalous state of the parts, part name candidates, or volume of the parts that are detected as being in the anomalous state.

By the above configuration, the part name can be linked up with the part number.

The part management system according to the present disclosure is characterized in that the part number identifying unit holds ancillary information including supply destinations of the parts or purpose of use of the parts.

By the above configuration, ancillary information can be used to select an approach to be taken.

The part management system according to the present disclosure is characterized in that the part name determination information acquisition unit includes:
a storage unit configured to store a machine learning device trained by being input with a plurality of training data sets each composed of a combination of an image of the part and a name of the part; and
a calculation unit configured to output the part name of the part by inputting a captured image of the part into the trained machine learning device read out from the storage unit.

By the above configuration, the product names of the parts can be output automatically using a processing device that has been trained by machine learning.

A part management method according to the present disclosure includes:
a step of acquiring part delivery track record information;
a step of executing a simulation of a part storage space based on the acquired part delivery track record information;
a step of recording stored-parts information of the part storage space based on the simulation;
a step of photographing the part storage space and detecting parts that are in an anomalous state;
a step of acquiring part name determination information of the parts that have been detected as being in the anomalous state;
a step of identifying a part number of each of the respective parts that have been detected as being in the anomalous state by comparing the acquired part name determination information with the acquired stored-parts information;
a step of acquiring logistics operation information of the parts that have the identified part numbers and that have been detected as being in the anomalous state and calculating an approach to be taken for handling the parts that have been detected as being in the anomalous state, and
a step of displaying the calculated approach to be taken in handling the parts that have been detected as being in the anomalous state.

By the above configuration, it is possible to provide a part management method in which the number of processes that involve manual operation in managing materials is reduced.

According to the present disclosure, it is possible to provide a part management system in which the number of processes that involve manual operation in managing materials is reduced.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing a configuration of a part management system according to an embodiment;

FIG. 2 is a flowchart of a part management method according to an embodiment; and

FIG. 3 is a diagram showing a correspondence table of the stored-parts information and the part name determination information according to the embodiment.

### DESCRIPTION OF EMBODIMENTS

### Embodiments

Embodiments of the present disclosure will be described below with reference to the drawings. However, the embodiments are not intended to limit the scope of the present disclosure according to the claims. Further, not all of the components/structures described in the embodiments are necessarily indispensable as means for solving the problem. Note that the following description and the attached drawings are appropriately shortened and simplified where appropriate to clarify the explanation. In the drawings, the identical reference symbols denote identical structural elements, and the redundant explanation thereof is omitted.

(Description of Part Management System According to Embodiments)

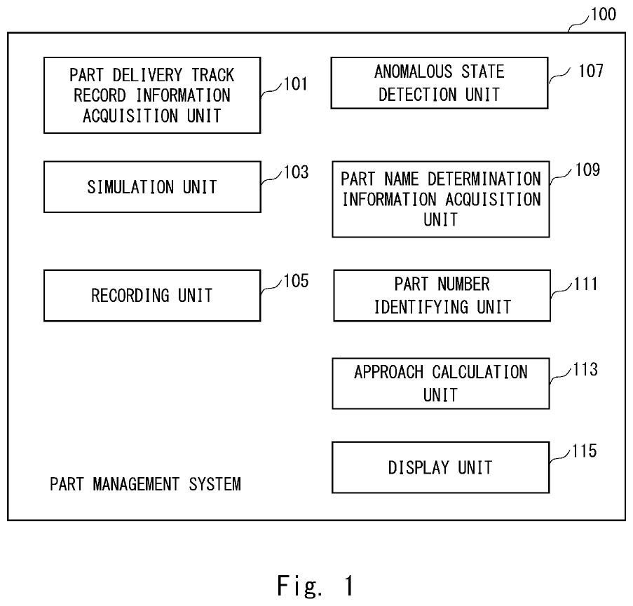

FIG. 1 is a block diagram showing a configuration of a part management system according to an embodiment. The part management system according to the embodiment will be described with reference to FIG. 1. In the embodiment, the anomalous state refers to a state in which parts have crowded-out from a storage space.

As shown in FIG. 1, a part management system 100 according to the embodiment includes a part delivery track record information acquisition unit 101, a simulation unit 103, a recording unit 105, an anomalous state detection unit 107, a part name determination information acquisition unit 109, a part number identifying unit 111, an approach calculation unit 113, and a display unit 115.

The part delivery track record information acquisition unit 101 is a unit having a function of acquiring part delivery track record information. The part delivery track record information acquisition unit 101 acquires delivery track record information on parts to be delivered on the day of delivery thereof in the storage space.

The simulation unit 103 performs simulation of the part storage space based on the part delivery track record information acquired by the part delivery track record information acquisition unit 101 and the existing part storage information. Here, the existing part storage information is the storage information of the parts that have been stored in the storage space on the day before the day of delivery thereof in the storage space. In simulation of the part storage space, for example, it is determined whether the parts have crowded-out from the part storage space.

The recording unit 105 records the part storage information based on the simulation performed by the simulation unit 103 and updates the existing part storage information. The recording unit 105 is, for example, a database. The part storage information includes the storage spaces where the parts are stored, the names of the parts, the part numbers of the parts, the volume of the parts, the supply destinations of the parts, the purpose of use of the parts, and the time. The names of the parts denote the types of the parts such as gears and wheels. The part numbers of the parts denote classification of the parts expressing more detailed information than the names of the parts, and indicate where on a vehicle the parts are used and the type of the vehicle on which the parts are used. For example, a gear with the same part name has different part numbers depending on the size of the gear. For example, each part number identifies how many parts are stored in which part storage space.

The anomalous state detection unit 107 is a unit having a function of photographing a part storage space and detecting occurrence of an anomalous state of the parts stored in the storage space. For example, the anomalous state detection unit 107 photographs the part storage space with an RGB camera. The anomalous state detection unit 107 detects, using AI or the like, a state in which the parts stored in the part storage space have crowded-out from the part storage space as an anomalous state.

A part name determination information acquisition unit 109 is a unit having a function of acquiring the part name determination information of the part in the anomalous state detected by the anomalous state detection unit 107. The part name determination information acquisition unit 109 is equipped with a storage unit that stores a trained machine learning device that is trained by being input with a plurality of training data sets. A training data set consists of a combination of images of parts and names of parts. Further, the part name determination information acquisition unit 109 is also equipped with a calculation unit that outputs the names of parts by inputting the captured images of the parts into the trained machine learning device read out from the storage unit. That is, the part name determination information acquisition unit 109 uses artificial intelligence (AI). In this way, the names of the parts can be automatically output using the information processing device that has been trained by machine learning. The part name determination information includes the storage space of parts in an anomalous state, the time of occurrence of the anomalous state, the part name candidates, and the volumes of the parts.

The part number identifying unit 111 is a unit having a function of identifying the respective part numbers of the parts that are in an anomalous state by comparing the part name judgment information acquired by the part name determination information acquisition unit 109 with the stored-parts information acquired by the simulation unit 103. The part number identifying unit 111 identifies the part number of the part based on the part storage space, time of occurrence of the anomalous state, part name candidates, or volume of the part. In this way, the part number identifying unit 111 can link up the part name with the part number. Ancillary information such as the storage space where the part is stored, the supply destination of the part, and the purpose of use of the part is held in the part that has been identified as being in the anomalous state.

The approach calculation unit 113 is a unit having a function of acquiring the logistics operation information of the parts in an anomalous state, the parts having the part numbers (OK?) identified by the part number identifying unit 111, and calculating an approach to be taken in handling the parts that are in an anomalous state. The logistics operation information is acquired from a logistic operation information database. The logistics operation information includes haulage priority rules and the approach to be taken in handling the parts that are in an anomalous state. Therefore, the approach calculation unit 113 can determine the order of haulage of parts by taking the haulage priority into account. Also, the approach calculation unit 113 can use ancillary information to select an approach to be taken in handling the parts that are in an anomalous state.

The display unit 115 is a unit having a function of displaying an approach to be taken calculated by the approach calculation unit 113. For example, the display unit 115 can be a liquid crystal display device, an EL (Electro Luminescence) display device, or the like.

In this way, it is possible to provide a part management system in which the number of processes that involve manual operation in managing materials can be reduced. In addition, the above functions can be realized using an information processing device. The information processing device can consist of one or more information processing devices. The information processing device may also perform some or all of its functions in the cloud.

(Description of Part Management Method According to Embodiment)

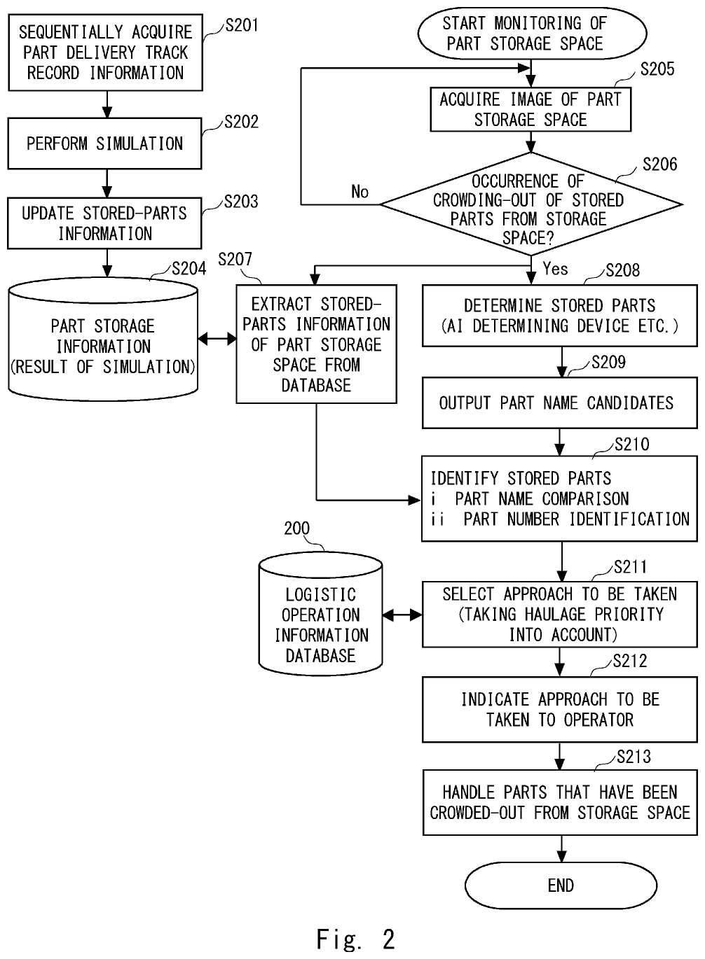

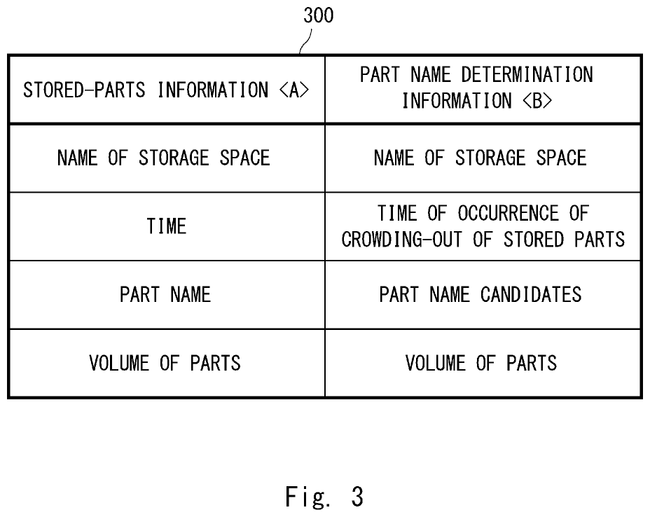

FIG. 2 is a flowchart of a part management system according to an embodiment. FIG. 3 is a diagram showing a correspondence table of stored-parts information and part name determination information according to an embodiment. A part management method according to an embodiment will be described with reference to FIGS. 2 and 3.

As shown in FIG. 2, as a first premise, the part delivery track record information acquisition unit 101 sequentially acquires part delivery track record information (Step S201). Next, the simulation unit 103 performs simulation of the part storage space (Step S202), adjusts the storage placement of the parts so that they are not crowded-out from the part storage space, and updates the stored-parts information (Step S203). Based on the part delivery track record information of the day and the existing part storage information, the simulation is executed to create the part storage information of the storage space of each stored part. After the simulation, the part management system 100 stores the updated part storage information in the recording unit 105, which is a database (Step S204).

The part management method is started with monitoring of the part storage space. The anomalous state detection unit 107 acquires an image of the part storage space (Step S205) and monitors whether or not crowding-out of the stored parts has occurred in the storage space (Step S206). If crowding-out of the stored parts has not occurred in the storage space (No in Step S206), the anomalous state detection unit 107 continues to monitor the part storage space (Step S205).

If crowding-out of the stored parts has occurred (Yes in Step S206), the part management system 100 extracts the stored-parts information of the part storage space from the database (Step S207). The part management system 100 uses information on the part storage space and the time of occurrence of crowding-out of the stored parts from the storage space as a nexus for performing extraction. Also, when crowding-out of the stored parts has occurred (Yes in Step S206), the part name determination information acquisition unit 109 uses an AI determining device to determine the stored parts that have been crowded-out from the storage space (Step S208). The part name candidates of the stored parts that have been determined to have been crowded-out from the storage space are then output (Step S209). The part name determination information acquisition unit 109 acquires images of the stored parts and acquires the part name candidates and data on the volume of the parts. The part name determination information acquisition unit 109 can automatically output part names using a machine-learned information processing device.

Next, the part number identifying unit 111 identifies the stored parts based on the stored-parts information obtained from the database and the acquired part name determination information (Step S210). Information on the stored parts is compared with the part name determination information, whereby the part number is identified. For example, as shown in the correspondence table 300 in FIG. 3, information retrieved from the stored-parts information <A> on the name of the storage space, the time, the part names, and the volume of the parts are compared with the corresponding information retrieved from the part name determination information <B> on the name of the storage space, the time of occurrence of crowding-out of the stored parts, the part name candidates, and the volume of the parts. The part number identifying unit 111 can link up the part name with the part number by referring to the above information. Each stored part holds ancillary information of the stored part such as the supply destination and the purpose of use in addition to the information on the part number. Next, the logistic operation information database 200 indicates the haulage priority of the stored parts and how to handle the parts that have been crowded-out to the approach calculation unit 113. The logistic operation information database 200 also indicates the ancillary information of the parts to the approach calculation unit 113. The approach calculation unit 113 selects an approach to be taken in handling the parts that have been crowded-out (Step S211). Ancillary information can be used in selecting an approach to be taken in handling the parts that have been crowded-out. The display unit 115 indicates, to the operator, the selected approach to be taken (Step S212). The approach to be taken is indicated to the operator using a PDA (Personal Digital Assistant) display device such as a tablet. Finally, the operator handles the parts that have been crowded-out from the storage space (Step S213) and the process ends.

In this way, the operator can deal with the crowding-out of the parts from the storage space as instructed by the information processing device and accordingly, it is possible to shorten the time during which the anomalous state is occurring. Therefore, it is possible to provide a part management method in which the number of processes that involve manual operation in managing materials is reduced.

A program can be stored and provided to a computer using any type of non-transitory computer readable media. Non-transitory computer readable media include any type of tangible storage media. The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals. Transitory computer readable media can provide the program to a computer via a wired communication line (e.g., electric wires, and optical fibers) or a wireless communication line.

Note that the present disclosure is not limited to the above-described embodiments and can be appropriately changed without departing from the gist of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A part management system comprising:
a part delivery track record information acquisition unit configured to acquire part delivery track record information;
a simulation unit configured to execute a simulation of a part storage space based on the acquired part delivery track record information;
a recording unit configured to record stored-parts information of the part storage space based on the simulation;
an anomalous state detection unit configured to photograph the part storage space to detect parts that are in an anomalous state;
a part name determination information acquisition unit configured to acquire part name determination information of the parts that have been detected as being in the anomalous state;
a part number identifying unit configured to identify a part number of each of the respective parts that are in the anomalous state by comparing the acquired part name determination information with the acquired stored-parts information;
an approach calculation unit configured to acquire logistics operation information of the parts that have the respective part numbers identified by the part number identifying unit and have been detected as being in the anomalous state, and to calculate an approach to be taken for handling the parts that have been detected as being in the anomalous state; and
a display unit configured to display the calculated approach to be taken in handling the parts that have been detected as being in the anomalous state.

2. The part management system according to claim 1, wherein the part name determination information includes at least one of information on a part storage space, the time of occurrence of the anomalous state of the parts, part name candidates, or volume of the parts that are detected as being in the anomalous state.

3. The part management system according to claim 1, wherein the part number identifying unit holds ancillary information including supply destinations of the parts or purpose of use of the parts.

4. The part management system according to claim 1, wherein the part name determination information acquisition unit includes:
a storage unit configured to store a machine learning device trained by being input with a plurality of training data sets each composed of a combination of an image of the part and a name of the part; and
a calculation unit configured to output the part name of the part by inputting a captured image of the part into the trained machine learning device read out from the storage unit.

5. A part management method comprising:
a step of acquiring part delivery track record information;
a step of executing a simulation of a part storage space based on the acquired part delivery track record information;
a step of recording stored-parts information of the part storage space based on the simulation;
a step of photographing the part storage space and detecting parts that are in an anomalous state;
a step of acquiring part name determination information of the parts that have been detected as being in the anomalous state;
a step of identifying a part number of each of the respective parts that have been detected as being in the anomalous state by comparing the acquired part name determination information with the acquired stored-parts information;
a step of acquiring logistics operation information of the parts that have the identified part numbers and that have been detected as being in the anomalous state and calculating an approach to be taken for handling the parts that have been detected as being in the anomalous state, and
a step of displaying the calculated approach to be taken in handling the parts that have been detected as being in the anomalous state.
